(19) United States
(12) Patent Application Publication
(10) Pub. No.: US 2005/0196594 A1
(43) Pub. Date: Sep. 8, 2005

(54) In-mold label composition and process

(75) Inventors: Dennis D. O'Rell, Geneva, IL (US); Arthur J. Malin, Northbrook, IL (US)

Correspondence Address: WELSH & KATZ, LTD. (ILLINOIS TOOL WORKS), 120 S. RIVERSIDE PLAZA, CHICAGO, IL, 60606, US

(73) Assignee: Illinois Tool Works, Inc., Glenview, IL (US)

(21) Appl. No.: 10/791,541

(22) Filed: Mar. 2, 2004

(51) Int. Cl. B32B 3/00

(52) U.S. Cl. 428/195.1

(57) ABSTRACT

An in-mold label composition includes a microporous sheet substrate having first and second faces and a first down coat of a film-forming polymer on the first face of the microporous sheet substrate. A graphic is printed on the first down coat of film-forming polymer after the first down coat has dried. A method of making the label and an article made with the label are also disclosed.

### BACKGROUND OF THE INVENTION

The present invention is directed to an in-mold label composition and process. More particularly, the present invention is directed to an in-mold label composition and a process in which the in-mold composition is carried out without, and the process is carried out without an overcoat on the graphics.

In-mold compositions and methods are used to provide graphics, e.g., decorations, in molded articles. Such in-mold techniques typically provide articles with a high quality, aesthetically appealing appearance and, in many instances, high quality performance. That is, the images or decorations can be near photographic quality and highly resistant to fading, chemicals, abrasion and the like.

To this end, the ability to provide a high quality graphic on an item is of extreme importance to many manufacturers. For example, in-mold label applications can be used for “all weather” signs, automobile mud flaps and plastic indoor and outdoor toys, coolers and the like. Many other outdoor items such as plastic or resin furniture can also be enhanced by such in-mold processes.

It will be readily recognized that these processes provide a much more aesthetically appealing decoration than, for example, pressure sensitive labels and the like. In addition, whereas labels can be peeled off or can rub off of products, typically, in-mold compositions cannot be easily removed.

In-mold compositions are known in the art. For example, Abrams et al., U.S. Pat. No. 6,544,634 discloses one composition and method in which a graphic is printed onto a micro-porous sheet, the micro-porous sheet is over-printed with clear screen ink, the image is positioned in a mold and a plastic injected in the mold to form the molded product with the graphic.

While such an in-mold composition and process function well, it has been found that the printing of an over coat increases the time and costs (and specifically, labor time and costs) necessary for achieving the high quality graphic. In that such processes are extremely cost sensitive (and time sensitive), such increases in time and costs are undesirable if not, perhaps, unacceptable.

Accordingly, there exists a need for an in-mold label composition and process that reduces the amount of time and costs associated with applying a high quality, durable graphic to a molded product. Desirably, such process eliminates any “back-end” over-printing of the printed graphics prior to application or positioning in a mold.

### SUMMARY OF THE INVENTION

An in-mold label composition includes a microporous sheet substrate having first and second faces and a first down coat of a film-forming polymer on the first face of the microporous sheet substrate. After the first down coat has dried, a graphic is printed on the dried first down coat, and the label is ready for use as an in-mold label. A method of making the label and an article made with the label are also disclosed.

The present in-mold label reduces the amount of time and costs associated with applying a high quality, durable graphic to a molded article in that no over-coating is required. As such, following down coating and printing, the label can be cut to an appropriate size and shape and used in the molding process.

These and other features and advantages of the present invention will be readily apparent from the following detailed description, in conjunction with the claims.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be understood that the title of this section of this specification, namely, “Detailed Description Of The Invention”, relates to a requirement of the United States Patent Office, and does not imply, nor should be inferred to limit the subject matter disclosed herein.

The present invention is directed to an in-mold composition and a process for making an in-mold composition. The composition provides a high quality graphic in cost effective package that is readily incorporated into the in-mold process.

The in-mold label is a microporous material (e.g., web) of a porous synthetic paper or non-woven material. A first down white or clear coat is applied to the web. A graphic image is then printed on the synthetic paper. The graphic image can be printed in any number of colors as required. The image (which is printed in ink) is then allowed to dry or is cured using radiation, such as ultraviolet light or electron beam radiation.

After the web has dried, the image is cut from the sheet into an appropriate size and shape. Such cutting should be to size and shape for the image to fit the final molded article. The image, or label, carrying the graphic representation is then inserted into a mold. The label is held in position in the mold by, for example, vacuum, electrostatic energy or the like.

The mold is then closed to define a mold cavity and the mold cavity is filled with a flowable polymer or elastomer. Optionally, the flowable material is cured in the mold. For example, if the material is a thermoset material, it can be cured by maintaining it at a sufficiently elevated temperature for a predetermined period of time. The mold is then opened and the molded part is removed therefrom. The molded part will have an integral graphic representation.

A preferred paper or non-woven material has a small pore size and controlled caliber. One porous synthetic paper that is used in the process is prepared from a thermoplastic material. A preferred thermoplastic material is ultra high molecular weight polyethylene, used alone or in blends with lower molecular weight polyethylenes or polyolefin copolymers. Suitable materials are disclosed in U.S. Pat. Nos. 4,861,644, 5,196,262, 5,326,391 and 6,114,023, the disclosures of which are incorporated herein by reference. Alternate systems based on polyesters, polyamides and halogenated polymers and the like are also contemplated to be suitable. For example, commercially available materials such as TESLIN® (a microporous, highly filled polyethylene matrix sheet material), commercially available from PPG of Pittsburgh, Pa.; DARAMIC® (another microporous polyethylene sheet material), commercially available from Daramic Inc., of Corydon, Ind.; SOLUFILL® and/or SOLUPOR®, both commercially available from DSM Solutech of the Netherlands and Teijin Fibers Limited of Japan; and TYVEK® (spun bonded polyethylene fibers), commercially available from E. I. du Pont de Nemours and Company, of Wilmington, Del. are anticipated to provide acceptable label substrate materials.

Optionally, the label can include porous inorganic fillers such as precipitated silica or diatomaceous earth to impart desired characteristics, such as increased micro porosity, increased thermal stability, resistance to flow at elevated temperatures, reduced dielectric strength (as compared to unfilled films), improved ink receptivity and the like. The non-woven web can be calendered to provide a smooth surface suitable for printing.

The first down clear or pigmented base coat should be a good film-forming composition in order to seal the microporous web. In particular, it has been found that such a base coat should seal the porosity of the label stock (or web) in order to increase resistance to water penetration. Experience shows that water penetration can adversely effect the web by carrying impurities into the material. This can result in color change, loss of image definition and the like. The first down coat, which seals the web, can be a solvent-based or a water-based material. The coating can be of the type that is dried using, for example, forced air drying ovens, ultraviolet light, electron beam exposure or the like to reduce the overall label printing and preparation time. It will be recognized that the drying parameters should take into consideration the prevention of thermal and/or radiation damage to the web or material. The drying process can also be a combination of forced air-drying and radiation curing.

Generally, the first down coat should have good resistance to yellowing on exposure to ultraviolet light. It is anticipated that coating systems including acrylic polymers, styrene-acrylic copolymers, aliphatic polyurethanes (having either polyether or polyester backbone), polyester resins, fluoropolymers and the like will provide suitable coating compositions. Resistance to ultraviolet (UV) light degradation can be increased by adding known UV light stabilizer compounds to the formulation. Examples of such commercially available stabilizers include hindered amine light stabilizers, benzotriazols, phosphites, antioxidants, and other additives that will be recognized by those skilled in the art.

One particular first down coat that has been found to be acceptable is prepared from JONCRYL® U4100, an aliphatic polyurethane dispersion commercially available from Johnson Polymers of Sturtevant, Wis. A preferred formulation is prepared from this dispersion and includes additional additives to improve ultraviolet light stability and thermal stability. Other additives include flow/leveling and anti-foam additives and optionally, titanium dioxide pigment and dispersing aids. This first down coat can be applied to the substrate by either printing it first, prior to the other colors as a full coverage image, or coating the web prior to printing. A preferred web is coated and dried prior to printing. This reduces the costs associated with coating and enhances the ability to control the level of deposit. Alternately, the web is coated with a radiation curable coating and cured prior to printing. Materials suitable for this process are commercially available from ink and coating companies, such as Environmental Inks and Coatings (EV Series of products) and BASF (Acronal® products).

The inks used for providing the graphic should be formulated to have increased resistance to degradation on exposure to weathering (including ultraviolet light exposure), moisture (in the form of rain, condensate, fog, vapor, high humidity and the like). The colorants in the ink should be fade resistant dyes or pigments, depending upon the end use requirements. Preferably, the ink is carried in a resin vehicle, which resin likewise has increased resistance to UV light degradation. Examples of such resins include, acrylic polymers, polyesters, polyurethane, silicones, alkyd resins, radiation curable urethanes, radiation curable silicones and the like. The inks can have enhanced or increased UV light degradation resistance through the use of UV stabilizer packages.

The ink selected for use depends on the type and chemical nature of the first down coat and the printing process that is used to generate the image. For the label to have good performance, the ink must securely bond to the first down coat. If the first down coat is an acrylic or urethane based resin coated from a solvent or water borne composition, conventional sheet-fed ink generally exhibits the required degree of bonding. If the first down coating is a radiation cured system (e.g., ultraviolet or electron beam radiation curing), a preferred ink is a radiation cured ink. Examples of some sheet-fed inks that function well with solvent or water based first down coatings include inks manufactured by Sun Chemical-GPI Ink, Flint Ink, INX and Akzo Nobel Inks. Examples of radiation cured inks for use on radiation cured first down coatings include inks manufactured by Sun Chemical, Sericol International, Environmental Inks and Coatings, and Toyo Ink Manufacturing Co.

A process for forming the in-mold composition includes applying to the web a first down clear or pigmented base coat. This provides a base for the graphic image produced by the printing of subsequent colors. It has been found that by providing this down coat first, subsequent overcoating operations are rendered unnecessary. It has also been found that, surprisingly, the down coat sufficiently protects the subsequently printed image so that the image can maintain the high quality necessary during use. In a typical process, following application of the first down clear or pigmented base coat, color processing printing (e.g., a four-color printing application) can be carried out sequentially applying black, magenta, cyan and yellow to form the image. The order of applying the inks can, of course, be varied to achieve to the desired image quality or appearance. Ink jet printing processes and the like may also be used to incorporate the coloring as desired. Spot colors, metallic foils and the like can also be used to achieve desired “special effects”.

Following the application of the inks, the web is allowed to dry, as necessary. In a typical process, the image is then cut from the web and is positioned in a mold. The image is positioned with the “printed” side out or against the surface of the mold. The image is held in place by vacuum or by the use of an electrostatic static charge. The first down coat helps to maintain the electrostatic charge differential between the image and the mold to maintain the image in place.

Once the image is in place, the mold is closed to form a mold cavity and a flowable polymer or elastomer is injected into the cavity. If necessary, the material can be cured in the mold, e.g., a thermoset material can be cured by maintaining it at a sufficiently elevated temperature for a predetermined period of time. The mold is then opened and the molded part is removed from the mold, with the part having an integral graphic representation.

All patents referred to herein, are hereby incorporated herein by reference, whether or not specifically done so within the text of this disclosure.

In the disclosures, the words “a” or “an” are to be taken to include both the singular and the plural. Conversely, any reference to plural items shall, where appropriate, include the singular.

From the foregoing it will be observed that numerous modification and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. An in-mold label composition comprising:
a microporous sheet substrate having first and second faces;
a first down coat of a film-forming polymer on the first face of the microporous sheet substrate; and
a graphic printed on the first down coat of film-forming polymer.

2. The in-mold label in accordance with claim 1 wherein the microporous sheet substrate is formed from a thermoplastic material.

3. The in-mold label in accordance with claim 2 wherein the thermoplastic material is ultra high molecular weight polyethylene.

4. The in-mold label in accordance with claim 2 wherein the thermoplastic material is ultra high molecular weight polyethylene blend.

5. The in-mold label in accordance with claim 1 wherein the first down coat is a solvent-based film-forming material.

6. The in-mold label in accordance with claim 1 wherein the first down coat is a water-based film-forming material.

7. The in-mold label in accordance with claim 1 wherein the first down coat is a radiation cured material.

8. The in-mold label in accordance with claim 1 wherein the first down coat is a polymer.

9. The in-mold label in accordance with claim 8 wherein the polymer is one or more of an acrylic polymer, a styrene-acrylic copolymer an aliphatic polyurethane, a polyester resin, and a fluoropolymer.

10. The in-mold label in accordance with claim 1 wherein the graphic is a printed media.

11. The in-mold label in accordance with claim 10 wherein the printed media is an ink.

12. The in-mold label in accordance with claim 11 wherein the ink is a colorant carrier by a resin vehicle, the resin vehicle being an acrylic polymer, a polyester, a polyurethane a silicone or an alkyd resin.

13. A method for making an in-mold label comprising the stops of:
providing a microporous sheet substrate having first and second faces;
coating the microporous sheet substrate with a first down coat of a film-forming polymer on the first face of the microporous sheet substrate;
drying the first down coat to form an undercoated sheet;
printing a graphic on the dried first down coat on the undercoated sheet;
drying the graphic.

14. The method in accordance with claim 13 wherein the step of drying the first down coat is by heating.

15. The method in accordance with claim 13 wherein the step of drying the first down coat is by irradiation.

16. The method in accordance with claim 13 wherein the step of drying the graphic is by heating.

17. The method in accordance with claim 13 wherein the step of drying the graphic is by irradiation.

18. The method in accordance with claim 13 including the steps of cutting the microporous sheet into a shape to form an in-mold label and inserting the in-mold label into a mold.

19. A method for making a molded article having an in-mold label comprising the steps of:
providing a microporous sheet substrate having first and second faces;
coating the microporous sheet substrate with a first down coat of a film-forming polymer on the first face of the microporous sheet substrate;
drying the first down coat to form an undercoated sheet;
printing a graphic on the dried first down coat on the undercoated sheet;
drying the graphic to form an in-mold label;
securing the in-mold label in a first portion of a mold;
closing the mold to define a mold cavity; and
introducing a polymer into the mold cavity to form the molded article.

20. The method in accordance with claim 19 including the step of curing the molded article.
